(19) United States
(12) Patent Application Publication
(10) Pub. No.: US 2024/0319473 A1
(43) Pub. Date: Sep. 26, 2024

(54) CAMERA ASSEMBLY AND ELECTRONIC DEVICE INCLUDING SAME

(71) Applicant: SAMSUNG ELECTRONICS CO., LTD., Suwon-si (KR)

(72) Inventors: Kyeongeun LEE, Suwon-si (KR); Sunggoo HER, Suwon-si (KR)

(21) Appl. No.: 18/731,959

(22) Filed: Jun. 3, 2024

Related U.S. Application Data
(63) Continuation of application No. PCT/KR2023/000054, filed on Jan. 3, 2023.

(30) Foreign Application Priority Data
Feb. 4, 2022 (KR) 10-2022-0014754
Mar. 7, 2022 (KR) 10-2022-0028832

(51) Int. Cl. G02B 7/02

(52) U.S. Cl. CPC G02B 7/022; G02B 7/021

(57) ABSTRACT

A camera assembly may include: a first camera module including a first optical component comprising a lens, a first camera housing configured to carry the first optical component, and a first coupling part comprising a hole or a boss positioned in the first camera housing; and a second camera module including a second optical component comprising a lens, a second camera housing configured to carry the second optical component, and a second coupling part comprising a hole or a boss positioned in the second camera housing and configured to be coupled to the first coupling part.

### CROSS-REFERENCE TO RELATED APPLICATIONS

This application is a continuation of International Application No. PCT/KR2023/000054 designating the United States, filed on Jan. 3, 2023, in the Korean Intellectual Property Receiving Office and claiming priority to Korean Patent Application Nos. 10-2022-0014754, filed on Feb. 4, 2022, and 10-2022-0028832, filed on Mar. 7, 2022, in the Korean Intellectual Property Office, the disclosures of each of which are incorporated by reference herein in their entireties.

### BACKGROUND

### Field

The disclosure relates to a camera assembly and an electronic device including the same.

Description of Related Art

Technologies for assembling camera modules within an electronic device are being developed. For example, the camera modules may be attached to a bracket, and a camera assembly in which a deviation between the camera modules is corrected may be assembled within the electronic device.

### SUMMARY

According to an example embodiment, a camera assembly may include: a first camera module including a first optical component, a first camera housing configured to carry the first optical component, and a first coupling portion comprising a hole positioned in the first camera housing, and a second camera module including a second optical component, a second camera housing configured to carry the second optical component, and a second coupling portion comprising a boss positioned in the second camera housing and configured to be coupled to the first coupling portion.

According to an example embodiment, an electronic device may include: a housing including a first plate and a second plate opposite to the first plate, and a camera assembly positioned between the first plate and the second plate, wherein the camera assembly may include a first camera module including a first optical component, a first camera housing configured to carry the first optical component, and a first coupling portion comprising a hole positioned in the first camera housing, and a second camera module including a second optical component, a second camera housing configured to carry the second optical component, and a second coupling portion comprising a boss positioned in the second camera housing and configured to be coupled to the first coupling portion.

### BRIEF DESCRIPTION OF THE DRAWINGS

The above and other aspects, features, and advantages of certain embodiments in the present disclosure will be more apparent from the following detailed description, taken in conjunction with the accompanying drawings, in which:

FIG. 1 is a block diagram illustrating an example electronic device in a network environment according to various embodiments;

FIG. 2A is a front perspective view of an example electronic device according to various embodiments;

FIG. 2B is a rear perspective view of an example electronic device according to various embodiments;

FIG. 2C is an exploded perspective view of an example electronic device according to various embodiments;

FIG. 3 is a block diagram illustrating an example configuration of a camera module according to various embodiments;

FIG. 4A is a cross-sectional view of an electronic device according to various embodiments;

FIG. 4B is a diagram illustrating a plan view of a camera assembly according to various embodiments;

FIG. 4C is a diagram illustrating a side view of a camera assembly according to various embodiments;

FIG. 4D is a diagram illustrating a partial plan view of a portion of a first camera module according to various embodiments;

FIG. 4E is a diagram illustrating a plan view of a portion of a second camera module according to various embodiments;

FIG. 5 is a diagram illustrating a plan view of a camera assembly according to various embodiments;

FIG. 6A is a diagram illustrating a first coupling portion and a second coupling portion of a camera assembly according to various embodiments;

FIG. 6B is a diagram illustrating a plan view of a first coupling portion and a second coupling portion of a camera assembly according to various embodiments;

FIG. 7A is a diagram illustrating a plan view of a camera assembly according to various embodiments; and

FIG. 7B is a diagram illustrating a first coupling portion and a second coupling portion of a camera assembly according to various embodiments.

### DETAILED DESCRIPTION

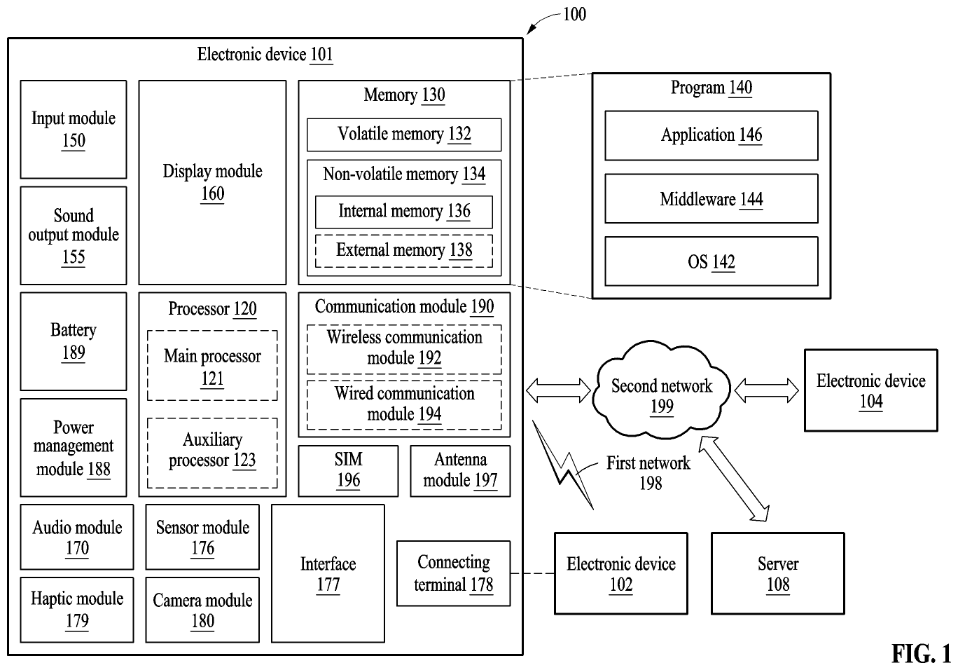

FIG. 1 is a block diagram illustrating an example electronic device in a network environment according to various embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added in the electronic device 101. In various embodiments, some (e.g., the sensor module 176, the camera module 180, or the antenna module 197) of the components may be integrated as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 connected to the processor 120, and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented as separate from, or as part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An artificial intelligence model may be generated through machine learning. Such learning may be performed, e.g., by the electronic device 101 where the artificial intelligence is performed, or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network, or a combination of two or more thereof, but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing a record. The receiver may be used to receive an incoming call. According to an embodiment, the receiver may be implemented separately from the speaker or as a portion of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to sense a touch, or a pressure sensor adapted to measure an intensity of a force incurred by the touch.

The audio module 170 may convert a sound into an electrical signal or vice versa. According to an embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a portion of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that operate independently of the processor 120 (e.g., an application processor) and support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may be transmitted or received between the communication module 190 and the external electronic device via the selected at least one antenna. According to an embodiment, another component (e.g., a radio frequency integrated circuit (RFIC)) other than the radiating element may be additionally formed as a portion of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mm Wave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of a same type as, or a different type from, the electronic device 101. According to an embodiment, all or some of operations to be executed by the electronic device 101 may be executed at one or more of external electronic devices (e.g., the external electronic devices 102 and 104, or the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, a home appliance, or the like. According to an embodiment of the disclosure, the electronic device is not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1st,” and “2nd,” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

As used in connection with embodiments of the disclosure, the term “module” may include a unit implemented in hardware, software, or firmware, or any combination thereof, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

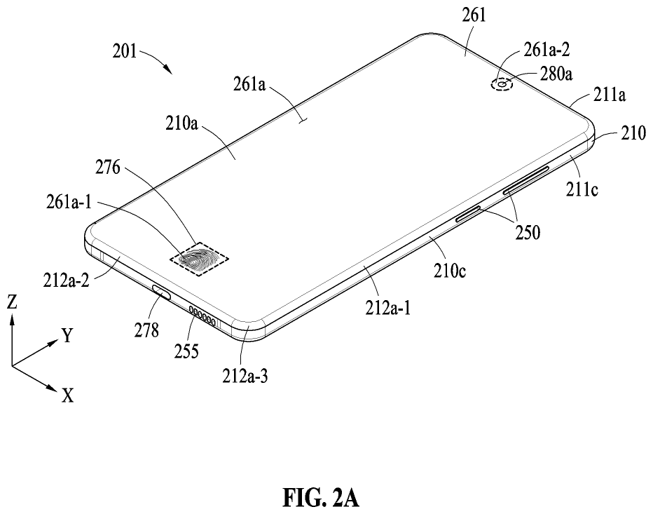

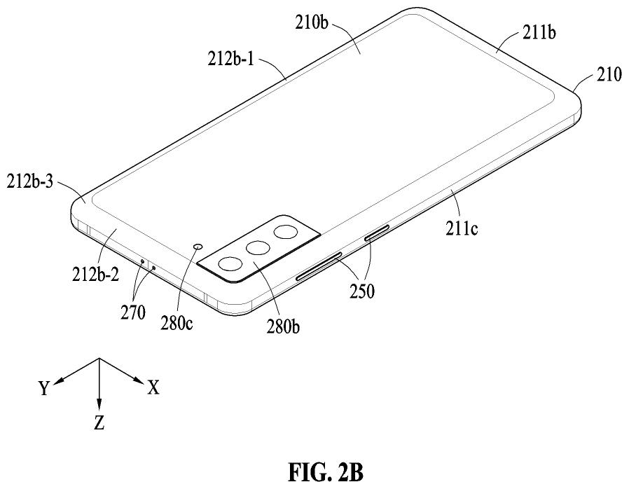

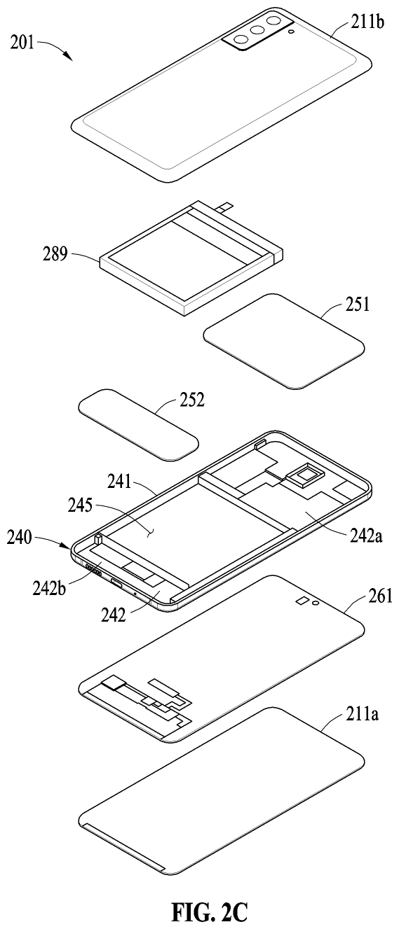

FIG. 2A is a front perspective view of an electronic device according to various embodiments. FIG. 2B is a rear perspective view of the electronic device according to various embodiments. FIG. 2C is an exploded perspective view of the electronic device according to various embodiments.

Referring to FIGS. 2A, 2B and 2C (which may be referred to as FIGS. 2A to 2C), an electronic device 201 (e.g., the electronic device 101 of FIG. 1) may include a housing 210 including a first surface 210a (e.g., a front surface), a second surface 210b (e.g., a rear surface), and a third surface 210c (e.g., a side surface) enclosing a space between the first surface 210a and the second surface 210b. The first surface 210a may be formed by a first plate 211a of which at least a portion is substantially transparent. For example, the first plate 211a may include a polymer plate or a glass plate including at least one coating layer. The second surface 211b may be formed by a second plate 211b that is substantially opaque. For example, the second plate 211b may be formed of coated or tinted glass, ceramic, polymer, metal (e.g., aluminum, stainless steel (STS), or magnesium), or a combination thereof. The third surface 210c may be formed by a frame 211c that is coupled to the first plate 211a and the second plate 211b and includes a metal and/or a polymer. The second plate 211b and the frame 211c may be integrally and seamlessly formed. The second plate 211b and the frame 211c may be formed of substantially the same material (e.g., aluminum).

In an embodiment, the first plate 211a may include a plurality of first periphery areas 212a-1. The plurality of first periphery areas 212a-1 may face the second plate 211b from at least a partial region of the first surface 210a. The plurality of first periphery areas 212a-1 may be rounded. The plurality of first periphery areas 212a-1 may extend in one direction (e.g., the +/−Y direction). The first plate 211a may include a plurality of second periphery areas 212a-2. The plurality of second periphery areas 212a-2 may face the second plate 211b from at least a partial region of the first surface 210a. The plurality of second periphery areas 212a-2 may be rounded. The plurality of second periphery areas 212a-2 may extend in another direction (e.g., the +/−X direction). The first plate 211a may include a plurality of third periphery areas 212a-3. The plurality of third periphery areas 212a-3 may face the second plate 211b from at least a partial region of the first surface 210a. The plurality of third periphery areas 212a-3 may be rounded. The plurality of third periphery areas 212a-3 may be between the plurality of first periphery areas 212a-1 and the plurality of second periphery areas 212a-2.

In an embodiment, the second plate 211b may include a plurality of fourth periphery areas 212b-1. The plurality of fourth periphery areas 212b-1 may face the first plate 211a from at least a partial region of the second surface 210b. The plurality of fourth periphery areas 212b-1 may be rounded. The plurality of fourth periphery areas 212b-1 may extend in one direction (e.g., the +/−Y direction). The second plate 211b may include a plurality of fifth periphery areas 212b-2. The plurality of fifth periphery areas 212b-2 may face the first plate 211a from at least a partial region of the second surface 210b. The plurality of fifth periphery areas 212b-2 may be rounded. The plurality of fifth periphery areas 212b-2 may extend in another direction (e.g., the +/−X direction). The second plate 211b may include a plurality of sixth periphery areas 212b-3. The plurality of sixth periphery areas 212b-3 may face the first plate 211a from at least a partial region of the second surface 210b. The plurality of sixth periphery areas 212b-3 may be rounded. The plurality of sixth periphery areas 212b-3 may be between the plurality of fourth periphery areas 212b-1 and the plurality of fifth periphery areas 212b-2.

In an embodiment, the electronic device 201 may include a display 261 (e.g., the display module 160 of FIG. 1). The display 261 may be positioned on the first surface 210a. The display 261 may be visible through at least a portion (e.g., the plurality of first periphery areas 212a-1, the plurality of second periphery areas 212a-2, and/or the plurality of third periphery areas 212a-3) of the first plate 211a. The display 261 may have a shape that is substantially the same as the shape of an outer edge of the first plate 211a. The periphery of the display 261 may substantially coincide with the outer edge of the first plate 211a. The display 261 may include a touch sensing circuit, a pressure sensor for measuring an intensity (pressure) of a touch, and/or a digitizer for detecting a magnetic-type stylus pen. The display 261 may include a screen display area 261a that is visible to display content using pixels. The screen display area 261a may include a sensing area 261a-1 and/or a camera area 261a-2. The sensing area 261a-1 may overlap at least one area of the screen display area 261a. The sensing area 261a-1 may allow transmission of an input signal related to a sensor module 276 (e.g., the sensor module 176 of FIG. 1). The sensing area 261a-1 may display content, like the screen display area 261a that does not overlap the sensing area 261a-1. For example, the sensing area 261a-1 may display the content while the sensor module 276 is not operating. The camera area 261a-2 may overlap at least one area of the screen display area 261a. The camera area 261a-2 may allow transmission of an optical signal related to a first camera assembly 280a (e.g., the camera module 180 of FIG. 1). The camera area 261a-2 may display content, like the screen display area 261a that does not overlap the camera area 261a-2. For example, the camera area 261a-2 may display the content while the first camera assembly 280a is not operating.

In an embodiment, the electronic device 201 may include an audio module 270 (e.g., the audio module 170 of FIG. 1). The audio module 270 may be positioned on the third surface 210c. The audio module 270 may obtain a sound through at least one hole.

In an embodiment, the electronic device 201 may include the sensor module 276. In an embodiment, the sensor module 276 may be positioned on the first surface 210a. The sensor module 276 may form the sensing area 261a-1 in at least a portion of the screen display area 261a. The sensor module 276 may receive an input signal transmitted through the sensing area 261a-1 and generate an electrical signal based on the received input signal. In an example, the input signal may have a designated physical quantity (e.g., heat, light, temperature, sound, pressure, or ultrasound). As another example, the input signal may include a signal related to biometric information (e.g., a fingerprint) of a user.

In an embodiment, the electronic device 201 may include the first camera assembly 280a, a second camera assembly 280b (e.g., the camera module 180 of FIG. 1), and a flash 280c. The first camera assembly 280a may be positioned on the first surface 210a, and the second camera assembly 280b and the flash 280c may be positioned on the second surface 210b. At least a portion of the first camera assembly 280a may be positioned under the display 261. The first camera assembly 280a may receive an optical signal transmitted through the camera area 261a-2. The second camera assembly 280b may include a plurality of camera modules (e.g., a dual camera, a triple camera, or a quad camera). The flash 280c may include a light-emitting diode or a xenon lamp.

In an embodiment, the electronic device 201 may include a sound output module 255 (e.g., the sound output module 155 of FIG. 1). The sound output module 255 may be positioned on the third surface 210c. The sound output module 255 may include one or more holes.

In an embodiment, the electronic device 201 may include an input module 250 (e.g., the input module 150 of FIG. 1). The input module 250 may be positioned on the third surface 210c. The input module 250 may include at least one key input device.

In an embodiment, the electronic device 201 may include a connecting terminal 278 (e.g., the connecting terminal 178 of FIG. 1). The connecting terminal 278 may be positioned on the third surface 210c. For example, when the electronic device 201 is viewed in one direction (e.g., the +Y direction), the connecting terminal 278 may be positioned at a central portion of the third surface 210c, and the sound output module 255 may be positioned on one side (e.g., a right side) with respect to the connecting terminal 278.

In an embodiment, the electronic device 201 may include a support body 240, a first circuit board 251, a second circuit board 252, and a battery 289 (e.g., the battery 189 of FIG. 1). At least a portion of the support body 240 may form the housing 210 together with the first plate 211a and the second plate 211b. The support body 240 may include a frame structure 241 (e.g., the frame 211c) and a plate structure 242. The frame structure 241 may be formed to surround a periphery of the plate structure 242. The frame structure 241 may connect the periphery of the first plate 211a and the periphery of the second plate 211b. The frame structure 241 may enclose a space between the first plate 211a and the second plate 211b. The frame structure 241 may form the third surface 210c of the electronic device 201. The plate structure 242 may include a first portion 242a for accommodating the first circuit board 251 and a second portion 242b for accommodating the second circuit board 252. The display 261 may be positioned on one surface (e.g., a bottom surface) of the plate structure 242, and the first circuit board 251 and the second circuit board 252 may be positioned on the other surface (e.g., a top surface) of the plate structure 242. The plate structure 242 may include an opening 245 positioned between the first portion 242a and the second portion 242b and passing through both surfaces of the plate structure 242. The opening 245 may accommodate the battery 289.

The description provided herein may also apply to electronic devices of various shapes/forms (e.g., a foldable electronic device, a slidable electronic device, a digital camera, a digital video camera, a tablet PC, a laptop computer, and other electronic devices), in addition to the electronic device shown in FIGS. 2A to 2C.

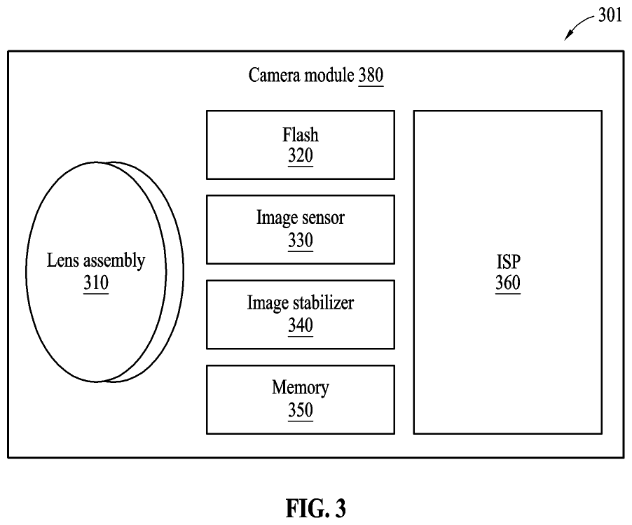

FIG. 3 is a block diagram illustrating an example configuration of a camera module according to various embodiments.

Referring to FIG. 3, a camera module 380 (e.g., the camera module 180 of FIG. 1 and/or the first camera assembly 280a and/or the second camera assembly 280b of FIGS. 2A to 2C) may include a lens assembly (e.g., including a lens) 310, a flash 320, an image sensor 330, an image stabilizer (e.g., including image stabilizing circuitry) 340, a memory 350 (e.g., buffer memory), or an image signal processor (ISP) (e.g., including processing circuitry) 360. The lens assembly 310 may include at least one lens and collect light emitted from an object which is a target of which an image is to be captured. The lens assembly 310 may include one or more lenses. According to an embodiment, the camera module 380 may include a plurality of lens assemblies 310. In this case, the camera module 380 may include, for example, a dual camera, a 360-degree camera, or a spherical camera. A portion of the lens assemblies 310 may have the same lens properties (e.g., an angle of view, a focal length, an auto focus, an f number, or an optical zoom), or at least one of the lens assemblies 310 may have one or more lens properties that are different from those of other lens assemblies. The lens assembly 310 may include, for example, a wide-angle lens or a telephoto lens.

The flash 320 may emit light to be used to enhance light emitted or reflected from the object. According to an embodiment, the flash 320 may include one or more light emitting diodes (LEDs) (e.g., a red-green-blue (RGB) LED, a white LED, an infrared (IR) LED, or an ultraviolet (UV) LED), or a xenon lamp. The image sensor 330 may obtain an image corresponding to the object by converting light emitted or reflected from the object and transmitted through the lens assembly 310 into an electrical signal. According to an embodiment, the image sensor 330 may include, for example, one image sensor selected from among image sensors having different properties, such as, for example, an RGB sensor, a black and white (BW) sensor, an IR sensor, or a UV sensor, a plurality of image sensors having the same property, or a plurality of image sensors having different properties. Each image sensor included in the image sensor 330 may be implemented using, for example, a charged coupled device (CCD) sensor or a complementary metal-oxide-semiconductor (CMOS) sensor.

The image stabilizer 340 may include various circuitry and move at least one lens included in the lens assembly 310 or the image sensor 330 in a specific direction, or control an operation characteristic (e.g., adjust the read-out timing) of the image sensor 330, in response to a movement of the camera module 380 or an electronic device 301 including the camera module 380. This may compensate for at least a portion of a negative effect of the movement on an image to be captured. According to an embodiment, the image stabilizer 340 may sense such a movement of the camera module 380 or the electronic device 301 using a gyro sensor (not shown) or an acceleration sensor (not shown) disposed inside or outside the camera module 380. According to an embodiment, the image stabilizer 340 may be implemented as, for example, an optical image stabilizer. The memory 350 may temporarily store therein at least a portion of the image obtained through the image sensor 330 for a subsequent image processing operation. For example, when image acquisition is delayed by a shutter or a plurality of images is obtained at a high speed, an obtained original image (e.g., a Bayer-patterned image or a high-resolution image) may be stored in the memory 350 and a copy image (e.g., a low-resolution image) corresponding the original image may be previewed through the display module 160. Subsequently, when a specified condition (e.g., a user input or a system command) is satisfied, at least a portion of the original image stored in the memory 350 may be obtained and processed by, for example, the ISP 360. According to an embodiment, the memory 350 may be configured as at least part of the memory 130 or as a separate memory operated independently of the memory 130.

The ISP 360 may include various processing circuitry and perform one or more image processing operations on an image obtained through the image sensor 330 or an image stored in the memory 350. The image processing operations may include, for example, depth map generation, three-dimensional (3D) modeling, panorama generation, feature point extraction, image synthesis, or image compensation (e.g., noise reduction, resolution adjustment, brightness adjustment, blurring, sharpening, or softening. Additionally or alternatively, the ISP 360 may control at least one of the components (e.g., the image sensor 330) included in the camera module 380. For example, the ISP 360 may control an exposure time, a read-out timing, and the like. The image processed by the ISP 360 may be stored again in the memory 350 for further processing, or be provided to an external component (e.g., the memory 130, the display module 160, the electronic device 102, the electronic device 104, or the server 108 of FIG. 1) of the camera module 380. According to an embodiment, the ISP 360 may be configured as at least part of the processor 120 or as a separate processor operated independently of the processor 120. When the ISP 360 is configured as a processor separate from the processor 120, at least one image processed by the ISP 360 may be displayed as it is without a change or be displayed through the display module 160 after additional image processing is performed by the processor 120.

According to an embodiment, the electronic device 301 may include a plurality of camera modules 380 having different properties or functions. In this case, for example, at least one of the camera modules 380 may be a wide-angle camera, and at least another one of the camera modules 380 may be a telephoto camera. Similarly, at least one of the camera modules 380 may be a front camera, and at least another one of the camera modules 380 may be a rear camera.

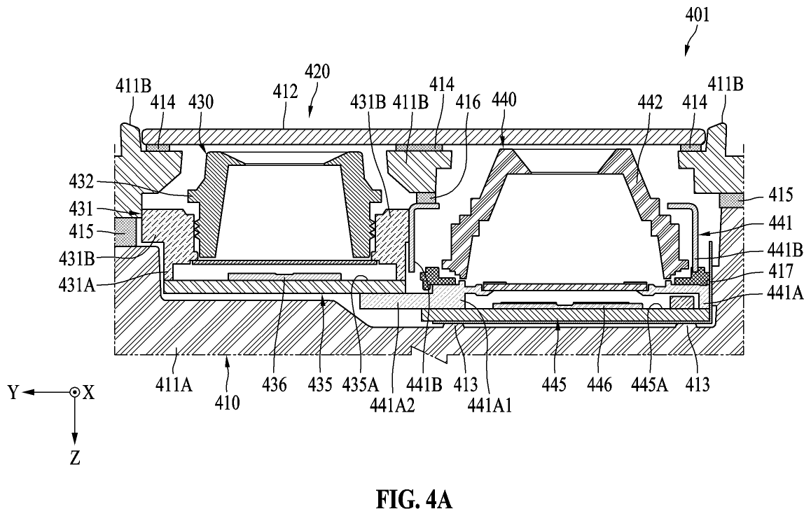

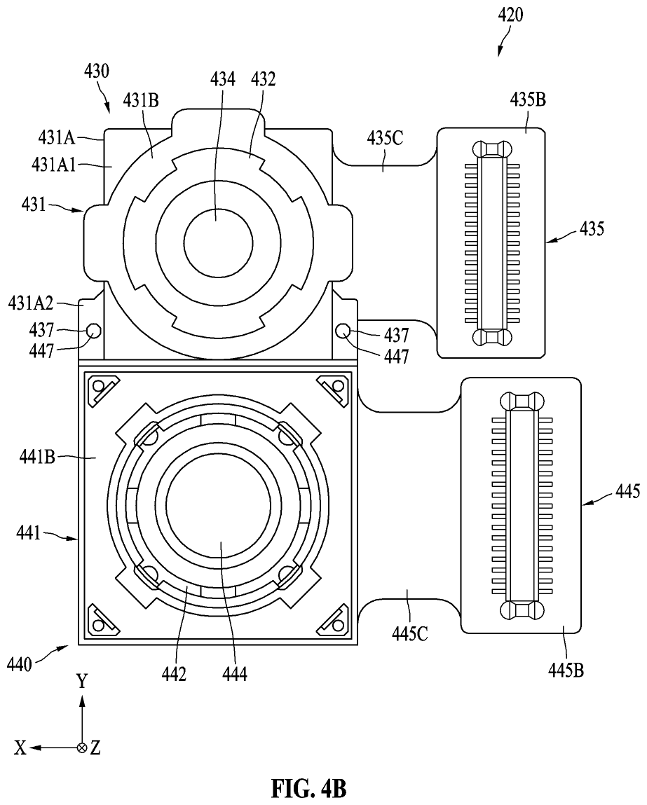

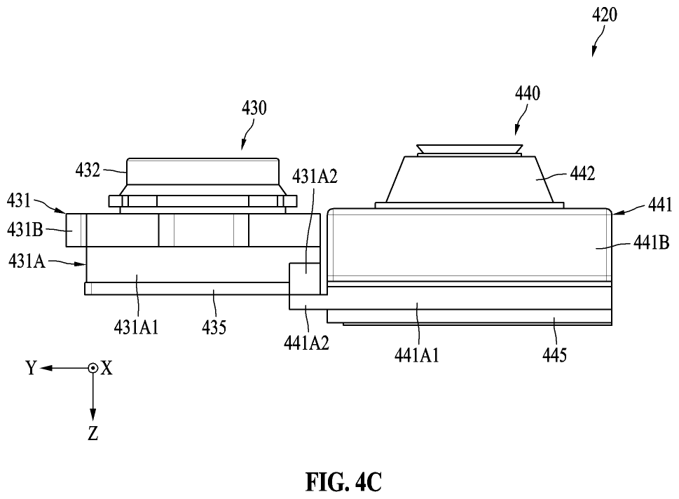

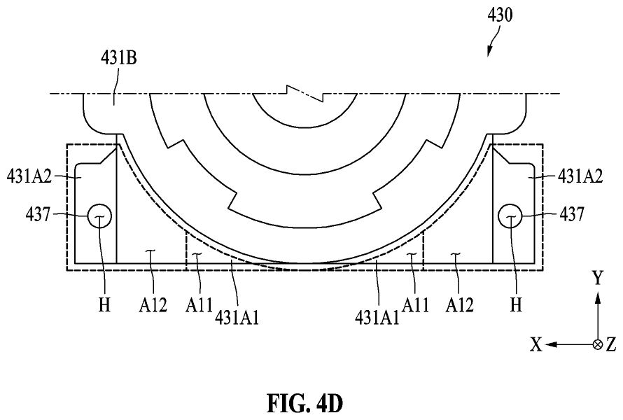

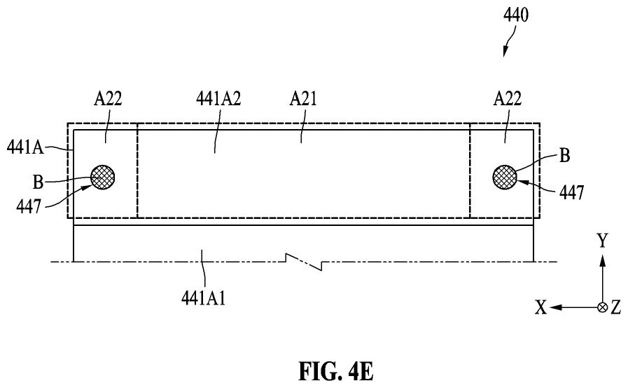

FIG. 4A is a cross-sectional view illustrating an example electronic device according to various embodiments. FIG. 4B is a diagram illustrating a plan view of a camera assembly according to various embodiments. FIG. 4C is a diagram illustrating a side view of the camera assembly according to various embodiments. FIG. 4D is diagram illustrating a plan view of a portion of a first camera module according to various embodiments. FIG. 4E is a diagram illustrating a plan view of a portion of a second camera module according to various embodiments.

Referring to FIGS. 4A, 4B, 4C, 4D and 4E (which may be referred to as FIGS. 4A to 4E), an electronic device 401 (e.g., the electronic device 101 of FIG. 1, the electronic device 201 of FIGS. 2A to 2C, and/or the electronic device 301 of FIG. 3) may include a housing 410. The housing 410 may include a first plate 411A (e.g., the first plate 211a of FIGS. 2A to 2C). The housing 410 may include a second plate 411B (e.g., the second plate 211b of FIGS. 2A to 2C). The first plate 411A may form a first surface (e.g., a front surface or the first surface 210a of FIG. 2A) of the housing 410. The second plate 411B may form a second surface (e.g., a rear surface or the second surface 210b of FIG. 2B) that is opposite to the first surface of the housing 410.

In an embodiment, the housing 410 may include a window 412 positioned on the second plate 411B. The window 412 may be at least partially formed of a transparent material. For example, the window 412 may include a polymer plate or a glass plate including at least one coating layer.

In an embodiment, the first plate 411A may include at least one support sheet (e.g., two support sheets) 4B formed on at least a portion of an inner surface of the first plate 411A. The support sheet 413 may protrude from an inner surface of the first plate 411A in one direction (e.g., the −Z direction). The support sheet 413 may have a substantially flat protruding plane. The support sheet 413 may, for example, support a component (e.g., the second camera module 440) and thereby seat the component within the housing 410.

In an embodiment, the housing 410 may include at least one elastic fixing portion 414, 415, and 416. The at least one elastic fixing portion 414, 415, and 416 may be configured to elastically deform. The at least one elastic fixing portion 414, 415, and 416 may be configured to support components within the housing 410 in one direction (e.g., the +/−Z direction). For example, the at least one elastic fixing portion 414, 415, and 416 may be formed of a porous, soft material such as a sponge.

In an embodiment, the housing 410 may include at least one first elastic fixing portion 414. The at least one first elastic fixing portion 414 may be positioned between the second plate 411B and the window 412. The housing 410 may include at least one second elastic fixing portion 415. The at least one second elastic fixing portion 415 may be positioned between the first plate 411A and the second plate 411B. The housing 410 may include at least one third elastic fixing portion 416. The at least one third elastic fixing portion 416 may be positioned between the second camera housing 441 and the second plate 411B.

In an embodiment, the housing 410 may include at least one guide 417. The at least one guide 417 may be configured to guide at least one component (e.g., the second camera housing 441) in one direction (e.g., the +/−Z direction). The guide 417 may protrude from a side surface of the first plate 411A in one direction (e.g., the +/−Y direction).

In an embodiment, the electronic device 401 may include a camera assembly 420 (e.g., the second camera assembly 280b of FIG. 2B). The camera assembly 420 may include a plurality of camera modules 430 and 440. The camera assembly 420 may include a first camera module 430 having a first aperture and a first viewing angle, and a second camera module 440 having a second aperture different from the first aperture and a second viewing angle different from the first viewing angle. For example, the first camera module 430 may include a wide camera, and the second camera module 440 may include an ultra-wide camera.

In an embodiment, the first camera module 430 and the second camera module 440 may be positioned between the first plate 411A and the second plate 411B. The first camera module 430 and the second camera module 440 may be positioned to at least partially overlap the window 412.

In an embodiment, the first camera module 430 may include a first camera housing 431. The first camera module 430 may include a first lens barrel 432 configured to move within the first camera housing 431. The first camera module 430 may include a first lens 434 at least partially surrounded by the first lens barrel 432. The first camera module 430 may include a first PCB 435 positioned at least partially within the first camera housing 431. The first camera module 430 may include a first image sensor 436 (e.g., the image sensor 330 of FIG. 3) substantially aligned with an optical axis (e.g., the +/−Z axis) of the first lens 434 and positioned on the first PCB 435. Although not shown, the first camera module 430 may include, as optical components, an infrared filter, an image stabilizer (e.g., the image stabilizer 340 of FIG. 3), and other optical components in addition to the first lens 434.

In an embodiment, the first PCB 435 may include a first substrate area 435A positioned under the first lens barrel 432 to support the first image sensor 436. The first PCB 435 may include a first connector area 435B opposite to the first substrate area 435A. The first PCB 435 may include a first extension area 435C extending between the first substrate area 435A and the first connector area 435B. The first PCB 435 may be implemented as a flexible printed circuit board (FPCB).

In an embodiment, the second camera module 440 may include a second camera housing 441. The second camera module 440 may include a second lens barrel 442 configured to move within the second camera housing 441. The second camera module 440 may include a second lens 444 at least partially surrounded by the second lens barrel 442. The second camera module 440 may include a second PCB 445 positioned at least partially within the second camera housing 441. The second camera module 440 may include a second image sensor 446 (e.g., the image sensor 330 of FIG. 3) substantially aligned with an optical axis (e.g., the +/−Z axis) of the second lens 444 and positioned on the second PCB 445. Although not shown, the second camera module 440 may include, as optical components, an infrared filter, an image stabilizer (e.g., the image stabilizer 340 of FIG. 3), and other optical components in addition to the second lens 444.

In an embodiment, the second PCB 445 may include a second substrate area 445A positioned under the second lens barrel 442 to support the second image sensor 446. The second PCB 445 may include a second connector area 445B opposite to the second substrate area 445A. The second PCB 445 may include a second extension area 445C extending between the second substrate area 445A and the second connector area 445B. The second PCB 445 may be implemented as an FPCB.

In an embodiment, the first camera housing 431 may include a first base 431A. The first camera housing 431 may include a first side wall 431B on the first base 431A. The first base 431A and the first side wall 431B may be integrally and seamlessly formed. The first base 431A and the first side wall 431B may be connected, coupled, or combined with each other through double injection.

In an embodiment, the first base 431A may include a first bottom portion 431A1 configured to support the first lens barrel 432. The first base 431A may include one or more (e.g., two) first stoppers 431A2 configured to restrict movement of the second base 441A in one direction (e.g., +/−Z direction). The first stoppers 431A2 may extend from at least a portion (e.g., a portion of an edge) of the first bottom portion 431A1 in one direction (e.g., the +/−X direction).

In an embodiment, the first base 431A may include a plurality of first edge areas A11. The first base 431A may include a plurality of first corner areas A12. The plurality of first edge areas A11 may be defined as areas including at least a portion of the edges of the first bottom portion 431A1, and the plurality of first corner areas A12 may be defined as areas including the corners of the first bottom portion 431A1 and positioned between adjacent edges of the first bottom portion 431A1. A first corner area A12 may be defined as an area including a corner of the first bottom portion 431A1 and the first stoppers 431A2.

In an embodiment, the second camera housing 441 may include a second base 441A. The second camera housing 441 may include a second side wall 441B on the second base 441A. The second base 441A and the second side wall 441B may be connected, coupled, or combined with each other through double injection. The second base 441A and the second side wall 441B may be integrally and seamlessly formed.

In an embodiment, the second base 441A and the first base 431A may be positioned on different planes. For example, the second base 441A may be positioned under the first base 431A as shown in FIG. 4A. In an example not shown, the second base 441A may also be positioned on the first base 431A depending on the structure of the camera modules 430 and 440.

In an embodiment, the second base 441A may include a second bottom portion 441A1 configured to support the second lens barrel 442. The second base 441A may include one or more (e.g., two) second stoppers 441A2 configured to restrict movement of the first base 431A in one direction (e.g., the +/−Z direction). The second stoppers 441A2 may extend from the second bottom portion 441A1 in one direction (e.g., the +Y direction).

In an embodiment, the second base 441A may include a plurality of second edge areas A21. The second base 441A may include a plurality of second corner areas A22. The plurality of second edge areas A21 may be defined as areas including at least a portion of the edges of the second bottom portion 441A1. The plurality of second corner areas A22 may be defined as areas including the corners of the second bottom portion 441A1 and positioned between adjacent edges of the second bottom portion 441A1. A second edge area A21 may be defined as an area including a portion of an edge of the second stoppers 441A2. A second corner area A22 may be defined as an area including a corner of the second stoppers 441A2 and a portion of an edge of the second stoppers 441A2.

In an embodiment, the first camera module 430 may include a first coupling portion 437 positioned in the first camera housing 431. The second camera module 440 may include a second coupling portion 447 positioned in the second camera housing 441 and configured to be coupled with the first coupling portion 437.

In an embodiment, the first coupling portion 437 and the second coupling portion 447 may be directly coupled to each other. The direct coupling of the first coupling portion 437 and the second coupling portion 447 may induce easy coupling of the first camera module 430 and the second camera module 440 without another mechanical component (e.g., a +/−Z-axial guide and/or a bracket for coupling modules). Utilization of space for placing the camera assembly 420 within the housing 410 and additional calibration between the camera modules 430 and 440 may be reduced or eliminated. The reaction force of the first PCB 435 and/or the second PCB 445 may be reduced. A tilt phenomenon caused by the camera modules 430 and 440 being stuck in the housing 410 may be eliminated. When the distance between the camera modules 430 and 440 decreases, the appearance of the electronic device 401 may improve.

In an embodiment, the first coupling portion 437 may include a hole H. The second coupling portion 447 may include a boss B to fit and be coupled with the hole H. The first coupling portion 437 may also include a boss B. The second coupling portion 447 may include a hole H to fit and be coupled with the boss B.

In an embodiment, the hole H and the boss B may be coupled by fit. The hole H and the boss B may be substantially coupled by interference fit.

In an embodiment, the first camera module 430 may include a plurality of (e.g., two) first coupling portions 437. The second camera module 440 may include a plurality of (e.g., two) second coupling portions 447 configured to be coupled to the plurality of first coupling portions 437, respectively. The coupling of the plurality of first coupling portions 437 and the plurality of second coupling portions 447 may reduce or suppress the relative rotation and/or tilt of the first camera module 430 and the second camera module 440.

In an embodiment, the plurality of first coupling portions 437 may be positioned on the first base 431A, and the plurality of second coupling portions 447 may be positioned on the second base 441A. The structure in which the coupling portions 437 and 447 are positioned on the bases 431A and 441A may allow easy design of the camera housings 431 and 441.

In an embodiment, the plurality of first coupling portions 437 may be spaced apart along one edge of the first base 431A. The plurality of second coupling portions 447 may be spaced apart along one edge of the second base 441A. The spaced structure of the coupling portions 437 and 447 may reduce or suppress the relative rotation and/or tilt of the first camera module 430 and the second camera module 440.

In an embodiment, the plurality of first coupling portions 437 may be respectively positioned in the first corner areas A12 of the first bottom portion 431A1. The plurality of second coupling portions 447 may be respectively positioned in the second corner areas A22 of the second bottom portion 441A1. The plurality of first coupling portions 437 may be respectively positioned in the first stoppers 431A2. The plurality of second coupling portions 447 may be respectively positioned in the second stoppers 441A2.

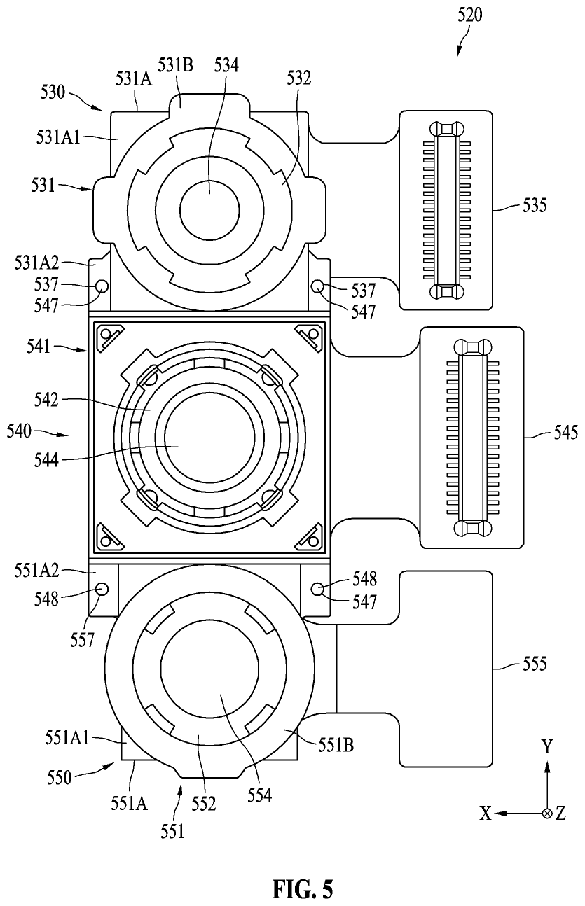

FIG. 5 is a diagram illustrating a plan view of a camera assembly according to various embodiments.

Referring to FIG. 5, a camera assembly 520 (e.g., the camera module 180 of FIG. 1, the first camera module 280a and/or the second camera module 280b of FIGS. 2A to 2C, the camera module 380 of FIG. 3, and/or the camera assembly 420 of FIGS. 4A to 4E) may include a first camera module 530 (e.g., the first camera module 430 of FIGS. 4A to 4E) having a first aperture and a first viewing angle, a second camera module 540 (e.g., the second camera module 440 of FIGS. 4A to 4E) having a second aperture different from the first aperture and a second viewing angle different from the first viewing angle, and a third camera module 550 having a third aperture different from the first aperture and the second aperture and a third viewing angle different from the first viewing angle and the second viewing angle. For example, the first camera module 530 may include a wide camera, the second camera module 540 may include an ultra-wide camera, and the third camera module 540 may include a telephoto camera.

In an embodiment, the first camera module 530 may include a first camera housing 531 (e.g., the first camera housing 431 of FIGS. 4A to 4E). The first camera module 530 may include a first lens barrel 532 (e.g., the second lens barrel 432 of FIGS. 4A to 4E). The first camera module 530 may include a first lens 534 (e.g., the first lens 434 of FIGS. 4A to 4E). The first camera module 530 may include a first PCB 535 (e.g., the first PCB 435 of FIGS. 4A to 4E). The first camera module 530 may include a plurality of first coupling portions 537 (e.g., the first coupling portions 437 of FIGS. 4A to 4E).

In an embodiment, the first camera housing 531 may include a first base 531A (e.g., the first base 431A of FIGS. 4A to 4E). The first camera housing 531 may include a first side wall 531B (e.g., the first side wall 431B of FIGS. 4A to 4E). The first base 531A may include a first bottom portion 531A1 (e.g., the first bottom portion 431A1 of FIGS. 4A to 4E). The first base 531A may include first stoppers 531A2 (e.g., the first stoppers 431A2 of FIGS. 4A to 4E).

In an embodiment, the second camera module 540 may include a second camera housing 541 (e.g., the second camera housing 441 of FIGS. 4A to 4E). The second camera module 540 may include a second lens barrel 542 (e.g., the second lens barrel 442 of FIGS. 4A to 4E). The second camera module 540 may include a second lens 544 (e.g., the second lens 444 of FIGS. 4A to 4E). The second camera module 540 may include a second PCB 545 (e.g., the second PCB 445 of FIGS. 4A to 4E). The second camera module 540 may include a plurality of second coupling portions 547 and 548 (e.g., the second coupling portions 447 of FIGS. 4A to 4E).

In an embodiment, the second camera housing 541 may include a second base (e.g., the second base 441A of FIGS. 4A to 4E). The second camera housing 541 may include a second side wall (e.g., the second side wall 441B of FIGS. 4A to 4E). The second base may include a second bottom portion (e.g., the second bottom portion 441A1 of FIGS. 4A to 4E). The second base may include second stoppers (e.g., the second stoppers 441A2 of FIGS. 4A to 4E).

In an embodiment, the third camera module 550 may include a third camera housing 551. The third camera module 550 may include a third lens barrel 552 configured to move within the third camera housing 551. The third camera module 550 may include a third lens 554 at least partially surrounded by the third lens barrel 552. The third camera module 550 may include a third PCB 555 positioned at least partially within the third camera housing 551. The third camera module 550 may include a third image sensor (not shown) substantially aligned with an optical axis (e.g., the +/−Z axis) of the third lens 554 and positioned on the third PCB 555. The third camera module 550 may include a plurality of (e.g., two) third coupling portions 557 configured to be coupled to some second coupling portions 547 among the plurality of second coupling portions 547 and 548, respectively. Although not shown, the third camera module 550 may include, as optical components, an infrared filter, an image stabilizer (e.g., the image stabilizer 340 of FIG. 3), and other optical components in addition to the third lens 554.

In an embodiment, the third camera housing 551 may include a third base 551A. The third camera housing 551 may include a third side wall 551B on the third base 551A. The third base 551A and the third side wall 551B may be integrally and seamlessly formed. The third base 551A and the third side wall 551B may be connected, coupled, or combined with each other through double injection.

In an embodiment, the third base 551A may include a third bottom portion 551A1 configured to support the third lens barrel 552. The third base 551A may include one or more (e.g., two) third stoppers 551A2 configured to restrict movement of the second base in one direction (e.g., the +/−Z direction). The third stopper 551A2 may extend from at least a portion (e.g., a portion of an edge) of the third bottom portion 551A1 in one direction (e.g., the +/−X direction).

In an embodiment, the plurality of third coupling portions 557 may be configured to be directly coupled to corresponding second coupling portions 548 among the plurality of second coupling portions 547 and 548, respectively.

In an embodiment, the second coupling portions 548 respectively corresponding to the plurality of third coupling portions 557 may include bosses (e.g., the boss B). The plurality of third coupling portions 557 may include holes (e.g., the hole H). The second coupling portions 548 respectively corresponding to the plurality of third coupling portions 557 may include holes (e.g., the hole H). The plurality of third coupling portions 557 may include bosses (e.g., the boss B).

In an embodiment, the plurality of second coupling portions 548 respectively corresponding to the plurality of third coupling portions 557 may be positioned, on the second base, in a portion opposite to the plurality of second coupling portions 547 respectively corresponding to the plurality of first coupling portions 537.

In an embodiment, the plurality of second coupling portions 548 may be spaced apart along one edge of the second base. The plurality of second coupling portions 548 may be positioned respectively in corner areas (e.g., the second corner area A22 of FIGS. 4A to 4E) of the second base (e.g., the second base 441A of FIGS. 4A to 4E). The plurality of second coupling portions 548 may be positioned respectively on the second stoppers (e.g., the second stopper 441A2 of FIGS. 4A to 4E).

In an embodiment, the plurality of third coupling portions 557 may be spaced apart along one edge of the third base 551A. The plurality of third coupling portions 557 may be positioned respectively in corner areas of the third base 551A. The plurality of third coupling portions 557 may be positioned respectively on the third stoppers 551A2.

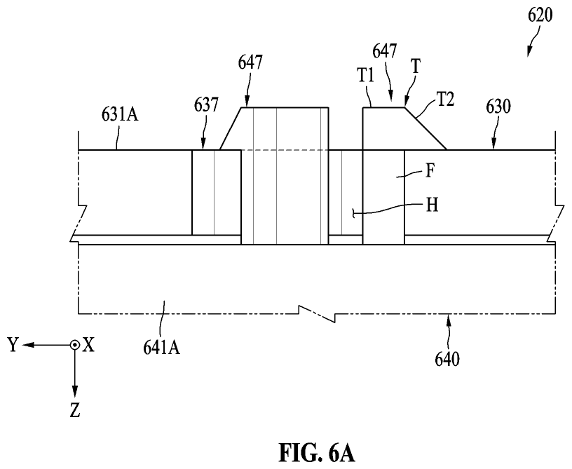

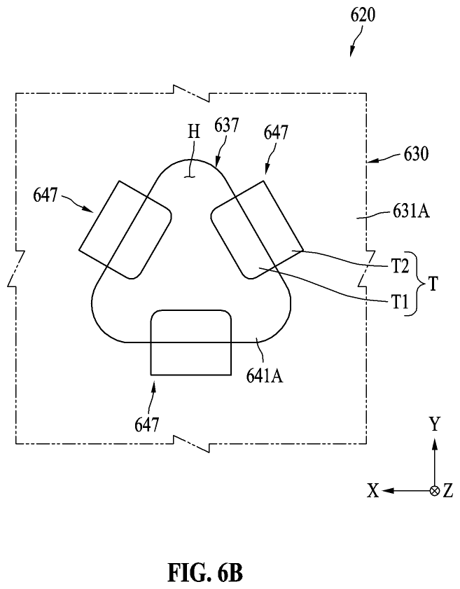

FIG. 6A is a is a diagram illustrating a first coupling portion and a second coupling portion of a camera assembly according to various embodiments. FIG. 6B is a diagram illustrating a plan view of the first coupling portion and the second coupling portion of the camera assembly according to various embodiments.

Referring to FIGS. 6A and 6B, a camera assembly 620 (e.g., the camera module 180 of FIG. 1, the first camera module 280a and/or the second camera module 280b of FIGS. 2A to 2C, the camera module 380 of FIG. 3, the camera assembly 420 of FIGS. 4A to 4E, and/or the camera assembly 520 of FIG. 5) may include a first camera module 630 (e.g., the first camera assembly 430 of FIGS. 4A to 4E and/or the first camera module 530 of FIG. 5). The first camera module 630 may include at least one first coupling portion 637 (e.g., the first coupling portion 437 of FIGS. 4A to 4E and/or the first coupling portion 537 of FIG. 5). The camera assembly 620 may include a second camera module 640 (e.g., the second camera module 440 of FIGS. 4A to 4E and/or the second camera module 540 of FIG. 5). The second camera module 640 may include at least one second coupling portion 647 (e.g., the second coupling portion 447 of FIGS. 4A to 4E and/or the second coupling portions 547 and 548 of FIG. 5). The first coupling portion 637 and the second coupling portion 647 may be coupled by fit. The first coupling portion 637 and the second coupling portion 647 may be coupled by interference fit.

In an embodiment, the first coupling portion 637 may include a hole H. The second coupling portion 647 may include an elastic body F, T to elastically fit with the hole H. The second coupling portion 647 may include a plurality of (e.g., three) elastic bodies F, T. The plurality of elastic bodies F, T may be arranged in the circumferential direction of the hole H. Alternatively, the first coupling portion 637 may include an elastic body F, T, and the second coupling portion 647 may include a hole H.

In an embodiment, the elastic body F, T may include a flexible flange F configured to extend from a second base 641A (e.g., the second base 441A) into the hole H and elastically deform. The elastic body F, T may include a tab T configured to be connected to an end portion of the flexible flange F and positioned on a first base 631A (e.g., the first base 431A). The flexible flange F may substantially contact a side surface of the hole H. The flexible flange F may at least partially form a gap with the side surface of the hole H.

In an embodiment, the flexible flange F and the tab T may be seamlessly and integrally formed. The flexible flange F and the tab T may be formed by double injection and connected, coupled, or combined with each other.

In an embodiment, the tab T may include a first tab T1 connected to the flexible flange F. The tab T may include a second tab T2 connected to the first tab T1 and supported on the first base 631A. The first tab T1 may have a surface substantially parallel to the first base 631A. The second tab T2 may have a surface inclined with respect to the first base 631A.

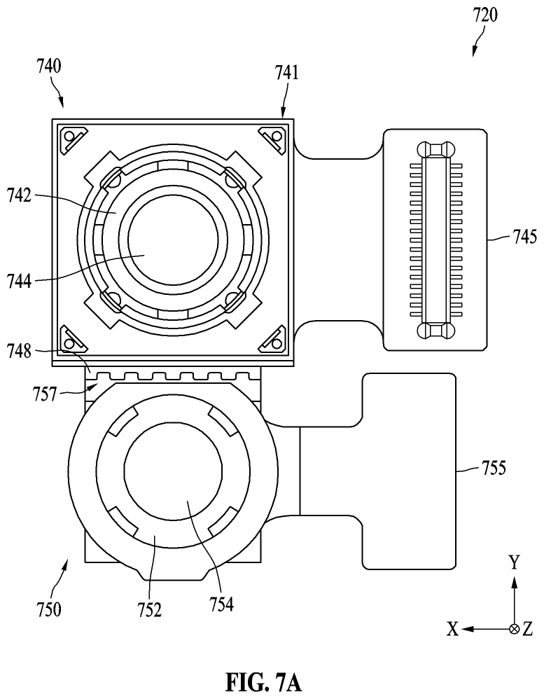

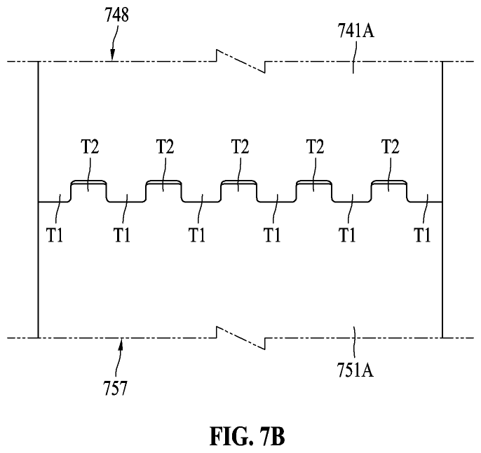

FIG. 7A is a diagram illustrating a plan view of a camera assembly according to various embodiments. FIG. 7B is a diagram illustrating a first coupling portion and a second coupling portion of the camera assembly according to various embodiments.

Referring to FIGS. 7A and 7B, a camera assembly 720 (e.g., the camera module 180 of FIG. 1, the first camera module 280a and/or the second camera module 280b of FIGS. 2A to 2C, the camera module 380 of FIG. 3, the camera assembly 420 of FIGS. 4A to 4E, the camera assembly 520 of FIG. 5, and/or the camera assembly 620 of FIGS. 6A and 6B) may include a first camera module 740 (e.g., the second camera module 440 of FIGS. 4A to 4E and/or the second camera module 540 of FIG. 5), and a second camera module 750 (e.g., the third camera module 550 of FIG. 5).

In an embodiment, the first camera module 740 may include a first camera housing 741 (e.g., the second camera housing 441 of FIGS. 4A to 4E and/or the second camera housing 541 of FIG. 5). The first camera module 740 may include a first lens barrel 742 (e.g., the second lens barrel 442 of FIGS. 4A to 4E and/or the second lens barrel 542 of FIG. 5). The first camera module 740 may include a first lens 744 (e.g., the second lens 444 of FIGS. 4A to 4E and/or the second lens 544 of FIGS. 4A to 4E). The first camera module 740 may include a first PCB 745 (e.g., the second PCB 445 of FIGS. 4A to 4E and/or the second PCB 545 of FIG. 5). The first camera module 740 may include a first coupling portion 748 (e.g., the second coupling portion 548 of FIG. 5).

In an embodiment, the second camera module 750 may include a second camera housing 751 (e.g., the third camera housing 551 of FIG. 5). The second camera module 750 may include a second lens barrel 752 (e.g., the third lens barrel 552 of FIG. 5). The second camera module 750 may include a third lens 754 (e.g., the third lens 554 of FIG. 5). The second camera module 750 may include a second PCB 755 (e.g., the third PCB 555 of FIG. 5). The second camera module 750 may include a second coupling portion 757 (e.g., the third coupling portion 557 of FIG. 5).

In an embodiment, the first coupling portion 748 and the second coupling portion 757 may engage with each other. The first coupling portion 748 may include a plurality of first teeth T1 arranged along one edge of a first base 741A (e.g., the second base 441A). The second coupling portion 757 may include a plurality of second teeth T2 arranged along one edge of a second base 751A (e.g., the third base 551A) to engage with the plurality of first teeth T1. The plurality of first teeth T1 and the plurality of second teeth T2 may substantially form spur gears.

Omitting a mechanical component (e.g., a bracket and/or a guide) to correct a deviation between camera modules may cause side effects. One aspect of the present disclosure may provide a camera assembly in which camera modules are coupled without a mechanical component (e.g., a bracket and/or a guide) to correct a deviation between camera modules, and an electronic device including the same.

According to an example embodiment, a camera assembly may include: a first camera module. The first camera module may include a first optical component comprising a lens. The first camera module may include a first camera housing configured to carry the first optical component. The first camera module may include a first coupling portion comprising a first hole or a first boss positioned in the first camera housing. The camera assembly may include a second camera module. The second camera module may include a second optical component comprising a lens. The second camera module may include a second camera housing configured to carry the second optical component. The second camera module may include a second coupling portion including a second hole or a second boss positioned in the second camera housing and configured to be coupled to the first coupling portion.

In an example embodiment, the first camera module may include a plurality of first coupling portions. The second camera module may include a plurality of second coupling portions configured to be respectively coupled to the plurality of first coupling portions.

In an example embodiment, the first camera housing may include a first base on which the plurality of first coupling portions are positioned. The second camera housing may include a second base on which the plurality of second coupling portions are positioned.

In an example embodiment, the plurality of first coupling portions may be spaced apart along an edge of the first base. The plurality of second coupling portions may be spaced apart along an edge of the second base.

In an example embodiment, the plurality of first coupling portions may be respectively positioned in corner areas of the first base. The plurality of second coupling portions may be respectively positioned in corner areas of the second base.

In an example embodiment, the first camera housing may further include a first stopper positioned on the first base. The second camera housing may further include a second stopper positioned on the second base and configured to meet the first stopper.

In an example embodiment, the first base may be positioned on the second base 41A.

In an example embodiment, the first coupling portion may include a first hole or a first boss. The second coupling portion may include a second hole configured to fit with the first boss or a second boss configured to fit with the first hole.

In an example embodiment, the first coupling portion may include a first hole or a first elastic body. The second coupling portion may include a second hole configured to elastically fit with the first elastic body or a second elastic body configured to elastically fit with the first hole.

In an example embodiment, the first elastic body or the second elastic body may include a flexible flange. The first elastic body or the second elastic body may include a tab positioned on an end portion of the flexible flange.

In an example embodiment, the first coupling portion may include a first hole or a plurality of first elastic bodies. The second coupling portion may include a second hole configured to elastically fit with the plurality of first elastic bodies or a plurality of second elastic bodies configured to elastically fit with the first hole.

In an example embodiment, the plurality of first elastic bodies may be spaced apart from each other in a circumferential direction of the second hole. The plurality of second elastic bodies may be spaced apart from each other in a circumferential direction of the first hole.

In an example embodiment, the first coupling portion and the second coupling portion may be configured to engage with each other.

In an example embodiment, the first coupling portion may include a plurality of first teeth. The second coupling portion may include a plurality of second teeth.

In an example embodiment, the first coupling portion and the second coupling portion may be coupled to each other by interference fit.

According to an example embodiment, an electronic device may include: a housing and a camera assembly arranged in the housing. The camera assembly may include a first camera module. The first camera module may include a first optical component comprising a lens. The first camera module may include a first camera housing configured to carry the first optical component. The first camera module may include a first coupling portion comprising a hole or a boss positioned in the first camera housing. The camera assembly may include a second camera module. The second camera module may include a second optical component comprising a lens. The second camera module may include a second camera housing configured to carry the second optical component. The second camera module may include a second coupling portion comprising a ball or hole positioned in the second camera housing and configured to be coupled to the first coupling portion.

In an example embodiment, the electronic device may further include a window at least partially overlapping the first camera module and/or the second camera module.

In an example embodiment, the electronic device may further include a guide configured to guide the first camera housing and/or the second camera housing.

In an example embodiment, the electronic device may further include a support sheet configured to support the first camera housing and/or the second camera housing.

In an example embodiment, the electronic device may further include an elastic fixing portion comprising an elastic material arranged in the housing.

According to an embodiment, it is possible to prevent and/or reduce a deviation between camera modules without a separate component for correcting the deviation between the camera modules. According to an embodiment, it is possible to reduce the reaction force of a PCB within an electronic device to which a camera assembly is applied. According to an embodiment, it is possible to reduce the tilt of camera module(s) within an electronic device. According to an embodiment, it is possible to reduce the distance between camera modules. The effects of the camera assembly and the electronic device including the same according to an embodiment may not be limited to the above-mentioned effects, and other unmentioned effects may be clearly understood from the following description by one of ordinary skill in the art.

While the disclosure has been illustrated and described with reference to various example embodiments, it will be understood that the various example embodiments are intended to be illustrative and not limiting. It will be further understood by those skilled in the art that various changes in form and detail may be made without departing from the true spirit and full scope of the disclosure, including the appended claims and their equivalents. It will be further understood that any of the embodiment(s) described herein may be used in combination with any other embodiment(s) described herein.

What is claimed is:

1. A camera assembly, comprising:
a first camera module comprising a first optical component comprising a first lens, a first camera housing configured to carry the first optical component, and a first coupling portion comprising a first hole or a first boss positioned in the first camera housing; and
a second camera module comprising a second optical component comprising a second lens, a second camera housing configured to carry the second optical component, and a second coupling portion comprising a second hole or a second boss positioned in the second camera housing and configured to be coupled to the first coupling portion.

2. The camera assembly of claim 1, wherein
the first camera module comprises a plurality of first coupling portions, and
the second camera module comprises a plurality of second coupling portions configured to be respectively coupled to the plurality of first coupling portions.

3. The camera assembly of claim 2, wherein
the first camera housing comprises a first base on which the plurality of first coupling portions are positioned, the second camera housing comprises a second base on which the plurality of second coupling portions are positioned.

4. The camera assembly of claim 3, wherein the plurality of first coupling portions are spaced apart along an edge of the first base, the plurality of second coupling portions are spaced apart along an edge of the second base.

5. The camera assembly of claim 4, wherein the plurality of first coupling portions are respectively positioned in corner areas of the first base, and the plurality of second coupling portions are respectively positioned in corner areas of the second base.

6. The camera assembly of claim 3, wherein
the first camera housing further comprises a first stopper positioned on the first base, and
the second camera housing further comprises a second stopper positioned on the second base and configured to meet the first stopper.

7. The camera assembly of claim 3, wherein
the first base is positioned on the second base.

8. The camera assembly of claim 1, wherein
the first coupling portion comprises a first hole or a first boss, and
the second coupling portion comprises a second hole configured to fit with the first boss or a second boss configured to fit with the first hole.

9. The camera assembly of claim 1, wherein
the first coupling portion comprises a first hole or a first elastic body, and
the second coupling portion comprises a second hole configured to elastically fit with the first elastic body or a second elastic body configured to elastically fit with the first hole.

10. The camera assembly of claim 9, wherein
the first elastic body or the second elastic body comprises:
a flexible flange; and
a tab positioned on an end portion of the flexible flange.

11. The camera assembly of claim 1, wherein
the first coupling portion comprises a first hole or a plurality of first elastic bodies,
the second coupling portion comprises a second hole configured to elastically fit with the plurality of first elastic bodies or a plurality of second elastic bodies configured to elastically fit with the first hole

12. The camera assembly of claim 11, wherein the plurality of first elastic bodies are spaced apart from each other in a circumferential direction of the second hole, or the plurality of second elastic bodies are spaced apart from each other in a circumferential direction of the first hole.

13. The camera assembly of claim 1, wherein
the first coupling portion and the second coupling portion are configured to engage with each other.

14. The camera assembly of claim 13, wherein the first coupling portion comprises a plurality of first teeth, and the second coupling portion comprises a plurality of second teeth.

15. The camera assembly of claim 1, wherein
the first coupling portion and the second coupling portion are coupled to each other by interference fit.

16. An electronic device, comprising:
a housing; and
a camera assembly arranged in the housing,
wherein the camera assembly comprises:
a first camera module comprising a first optical component comprising a first lens, a first camera housing configured to carry the first optical component, and a first coupling portion comprising a first hole or a first boss positioned in the first camera housing; and
a second camera module comprising a second optical component comprising a second lens, a second camera housing configured to carry the second optical component, and a second coupling portion comprising a second hole or a second boss positioned in the second camera housing and configured to be coupled to the first coupling portion.

17. The electronic device of claim 16, further comprising:
a window at least partially overlapping the first camera module and/or the second camera module

18. The electronic device of claim 16, further comprising:
a guide configured to guide the first camera housing and/or the second camera housing.

19. The electronic device of claim 16, further comprising:
a support sheet configured to support the first camera housing and/or the second camera housing.

20. The electronic device of claim 16, further comprising:
an elastic fixing portion comprising an elastic material arranged in the housing.
